(19) United States
(12) Patent Application Publication
(10) Pub. No.: US 2005/0015762 A1
(43) Pub. Date: Jan. 20, 2005

(54) Methods and systems for deploying computer source code

(76) Inventors: Steven James Steckler, Overland Park, KS (US); Pavel Vladimirovich Vlasov, Lenexa, KS (US); Leonid Ayzenshtat, Sussex, WI (US)

Correspondence Address: John S. Beulick;Armstrong Teasdale LLP, Suite 2600, One Metropolitan Sq., St. Louis, MO, 63102, US

(21) Appl. No.: 10/457,580

(22) Filed: Jun. 9, 2003

(51) Int. Cl. G06F 9/44

(52) U.S. Cl. 717/176; 717/171

(57) ABSTRACT

A method for deploying source code from a version control system to at least one of a web server and an application server is provided. The method uses a build environment configured to be coupled to a client utility and a version control repository. The method includes prompting a deployer to invoke the client utility, extracting source code from the version control repository using the build environment, verifying promotion groups, building compiled modules to form an application, and deploying the application to at least one of a web server and an application server.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to deploying computer source code and, more particularly, to network-based methods and systems for deploying computer source code to selected web and application servers.

Software applications are commonly developed under a collaborative effort by multiple software developers operating within a client/server computing network. A software application is generally represented by one or more project files. Such files may, for example, comprise web pages which contain hypertext markup language (HTML). These files may link to other files within that same project. For example, linked files may represent web pages that are hyperlinked to the web page for the original project file.

The client/server computing environment allows multiple developers to share these project files and collectively work on and develop an application project. In such a computing environment, the software application (represented by one or more project files under development) is generally stored on the server and is accessed and modified by one or more developers residing at the client computers. A developer at the client computer may work on the software project by creating new files or editing existing files on the server. To edit an existing file, the developer typically obtains a copy of the project file from the server. When a new file is created or an existing file is edited, the developer eventually saves the file directly on the server. In the case where the file is linked to other files, the file is processed to identify any of these linked files which require corresponding modifications. The identified linked files are then also modified in accordance with the changes in the original file. These new or edited files are thereafter made available on the server for further potential development.

Business entities and other organizations oftentimes require such software development. These entities may, for example, require multiple concurrent software projects. These projects may be for a short duration (e.g., 60-90 days), use a small predefined set of technologies, and/or require frequent code moves. These entities may also deploy these software projects to multiple servers, and may have at least one server hosting multiple projects.

In these situations, business entities and other organizations may experience difficulties communicating the organization's coding and infrastructure guidelines to project teams when developing software. The business entities may also experience an increased probability of error from manual deployment of source code, conflicts between operations teams and project teams, and increased probability of error from different teams deploying source code to a staging server and a production server. In addition, changes in a computer system infrastructure may preclude the use of already existing source code. Moreover, pre-deploy and post-deploy validations may not, in some situations, be implemented in a manual deployment process.

### BRIEF DESCRIPTION OF THE INVENTION

In one aspect, a method for deploying source code from a version control system to at least one of a web server and an application server is provided. The method uses a build environment configured to be coupled to a client utility and a version control repository. The method includes prompting a deployer to invoke the client utility, extracting source code from the version control repository using the build environment, verifying promotion groups, building compiled modules to form an application, and deploying the application to at least one of a web server and an application server.

In another aspect, a network based system for deploying source code from a version control system to at least one of a web server and an application server is provided. The system includes a version control repository, a client utility, and a build environment. The build environment is configured to be coupled to the client utility and the version control repository. The build environment includes at least one of a development environment, a staging environment, a production environment, and a plurality of extractor servers for hosting a plurality of extractors. The build environment is configured to extract source code from the version control repository, verify promotion groups, build compiled modules to form an application; and deploy the application to at least one of a web server and an application server.

In another aspect, a computer program embodied on a computer readable medium for deploying source code from a version control system to at least one of a web server and an application server is provided. The program includes a code segment that prompts a deployer to invoke a client utility and then extracts source code from the version control repository using a build environment. The build environment is configured to be coupled to the client utility and the version control repository. The program also includes a code segment that verifies promotion groups, builds compiled modules to form an application, and deploys the application to at least one of a web server and an application server.

### BRIEF DESCRIPTION OF THE DRAWINGS

FIG. 1 is a flowchart illustrating an example prior art process of deploying source code.

FIG. 2 is a simplified block diagram of an E-Builder System (EBS) in accordance with one embodiment of the present invention.

FIG. 3 is an expanded version block diagram of an example embodiment of a server farm included in an EBS.

FIG. 4 is a flowchart illustrating example processes utilized by an EBS.

FIG. 5 is a deployment diagram illustrating an example embodiment of an EBS.

FIG. 6 is a flowchart illustrating example development processes utilized by an EBS.

FIG. 7 is a flowchart illustrating example build processes utilized by an EBS.

FIG. 8 is a block diagram illustrating an example embodiment of a hierarchy of build sets and a property/build script resolution process for an EBS.

### DETAILED DESCRIPTION OF THE INVENTION

Example embodiments of systems and processes that facilitate deployment of computer source code from a version control system to at least one of a web and application server through the use of an E-Builder System (EBS) are described below in detail. A technical effect of the systems and processes described herein include at least one of an automatic deployment of computer source code from a version control system, known as a PVCS Version Manager, to a development, a staging, and a production environment for building, compiling, packaging, and deploying files to a specific web or application server. (PVCS Version Manager is manufactured by Merant® International Limited Corporation, Newbury Berkshire, United Kingdom.)

In the example embodiment, the EBS includes two build servers and a client utility. The EBS retrieves archived source code from the PVCS Version Manager, performs a number of validations to determine whether the code is correct, and then deploys the code. A deployer, a person invoking the client utility, needs to only input a logical project name (e.g., ERCClaims/Web) and version label. The remaining parameters are stored in configuration files in the PVCS Version Manager and are automatically provided by the EBS at startup.

For purposes of this patent application, a software development project delivers a product that functions in the context of an infrastructure. Infrastructure is a set of software technologies running on physical nodes (also known as boxes). A product includes multiple components (e.g., jsp page, database table) organized into subsystems (e.g., web application and Oracle® database). (Oracle is a registered trademark of Oracle Corporation, Redwood City, Calif.) A subsystem is part of a product that represents particular technology and is deployed on a particular box. In the PVCS Version Manager, projects are represented by repositories and subsystems are represented by subprojects. A build process with EBS is a process of deployment of a subsystem from PVCS Version Manager subproject to a box. A builder project is a definition of deployment of a subsystem to a box.

In the example embodiment, EBS includes a build server, an environment version control repository, and a project definition files version control repository. The build server operates as a foreground process, a background process on Unix® OS, or as a service on Windows®X NT/2000/XP. (Unix is a registered trademark of American Telephone and Telegraph Company Corporation, New York, N.Y.; and Windows is a registered trademark of Microsoft Corporation, Redmond, Wash.). The environment version control repository includes build scripts, properties, and other technology-specific files. The project definition files version control repository includes project build parameters files.

The EBS enables a business entity to separate development and deployment processes in all environments; standardize build processes based on technology used and parameterize these processes based on at least one of project, environment, and server; version control build files; create an isolated build environment; add pre-validation and post-validation steps to the build process; and enforce adherence with infrastructure and architectural guidelines by incorporating them into build process.

In one embodiment, the EBS is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

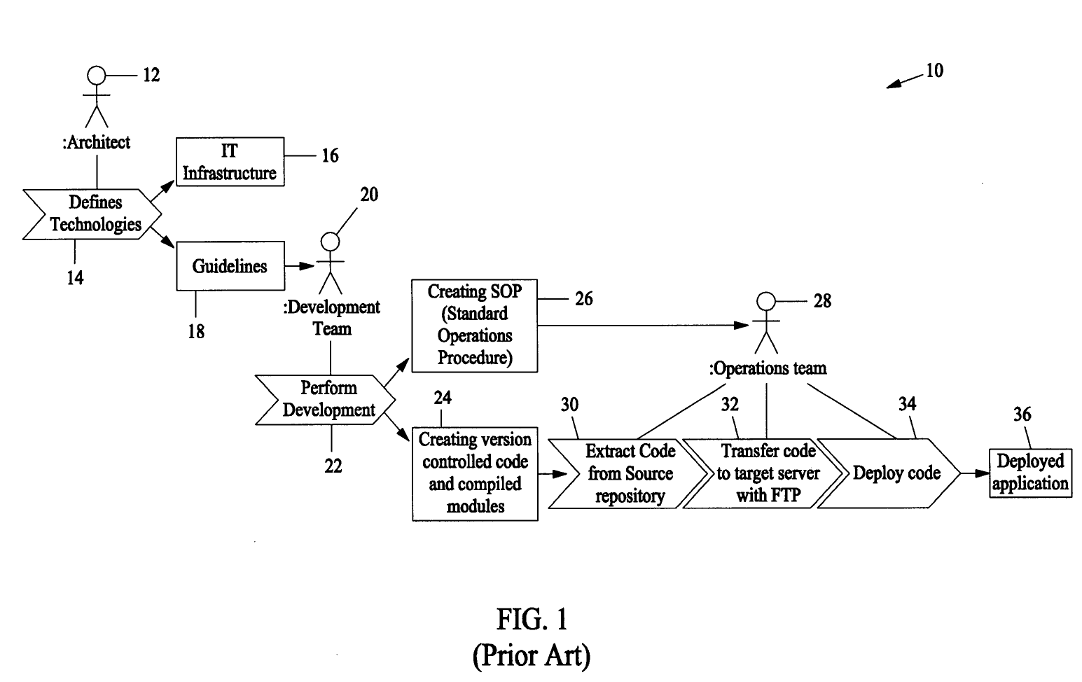

FIG. 1 is a flowchart 10 illustrating an example prior art process of deploying source code. An infrastructure architect 12 (i.e., an individual or a group performing architectural activities) defines 14 technologies to be used in an organization. The outputs of this process are IT infrastructure 16 and architectural guidelines 18. Architectural guidelines 18 are communicated 20 to development teams. The development teams perform 22 development including creating 24 product which is stored in a version control repository, and creating 26 SOP (Standard Operation Procedures) which are communicated 28 to an operations team. The operations team extracts 30 files from the version control repository, transfers 32 files to a target server with FTP (File Transfer Protocol), and deploys 34 code using SOP. This process results in a deployed 36 application.

Although this process results in a deployed application, this known process results in at least some known problems. For example, when communicating 20 architectural guidelines 18 from architect 12 to the development teams, it is difficult to attain a common understanding of guidelines 18 from the development team because such a team typically exists for only a relatively short period of time (e.g., 2-3 months) and includes mostly off-site members. Another potential problem with this known process includes misinterpretation of SOP by operations team or incompleteness/inconsistency of SOP.

During this known process, compilation is not performed during deployment, and thus, the version control repository contains compiled modules along with source code. Accordingly, the known process does not allow for traceability from source code to compiled modules. In addition, step 30 is not performed by version label and does not then verify that all files are in allowed promotion groups.

Furthermore, step 32 may lead to a high probability of error because some files will be transferred in binary mode while others are transferred in ASCII mode. Also, step 34 is performed manually and thus may result in a high probability of error. Finally, troubleshooting in the staging and production environments may be difficult within the known process because the development team does not have access to aforementioned environments and the operations team may have very limited knowledge of the application being deployed.

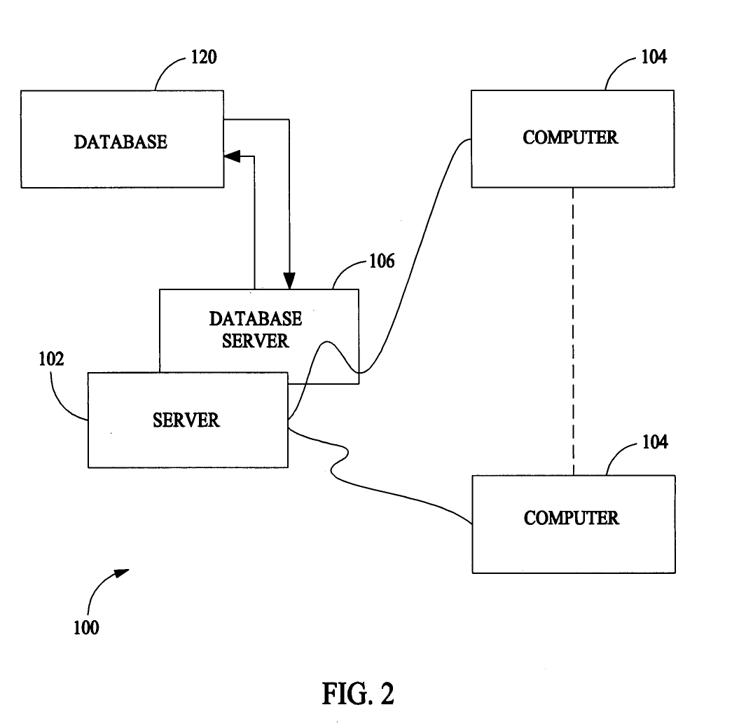

FIG. 2 is a simplified block diagram of an E-Builder System (EBS) 100 including a server system 102, and a plurality of client sub-systems, also referred to as client systems 104, connected to server system 102. In one embodiment, client systems 104 are computers including a web browser, such that server system 102 is accessible to client systems 104 via the Internet. Client systems 104 are interconnected to the Internet through many interfaces including a network, such as a local area network (LAN) or a wide area network (WAN), dial-in-connections, cable modems and special high-speed ISDN lines. Client systems 104 could be any device capable of interconnecting to the Internet including a web-based phone, personal digital assistant (PDA), or other web-based connectable equipment. A database server 106 is connected to a database 120 containing information on a variety of matters, as described below in greater detail. In one embodiment, centralized database 120 is stored on server system 102 and can be accessed by potential users at one of client systems 104 by logging onto server system 102 through one of client systems 104. In an alternative embodiment, database 120 is stored remotely from server system 102 and may be non-centralized.

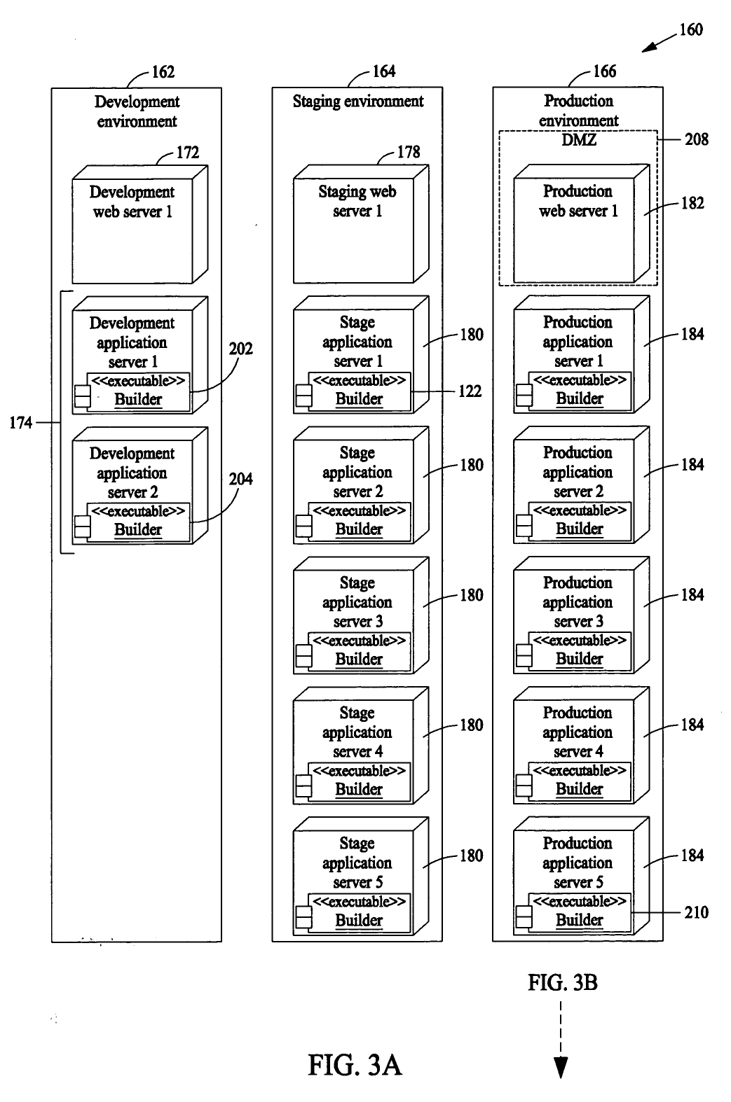

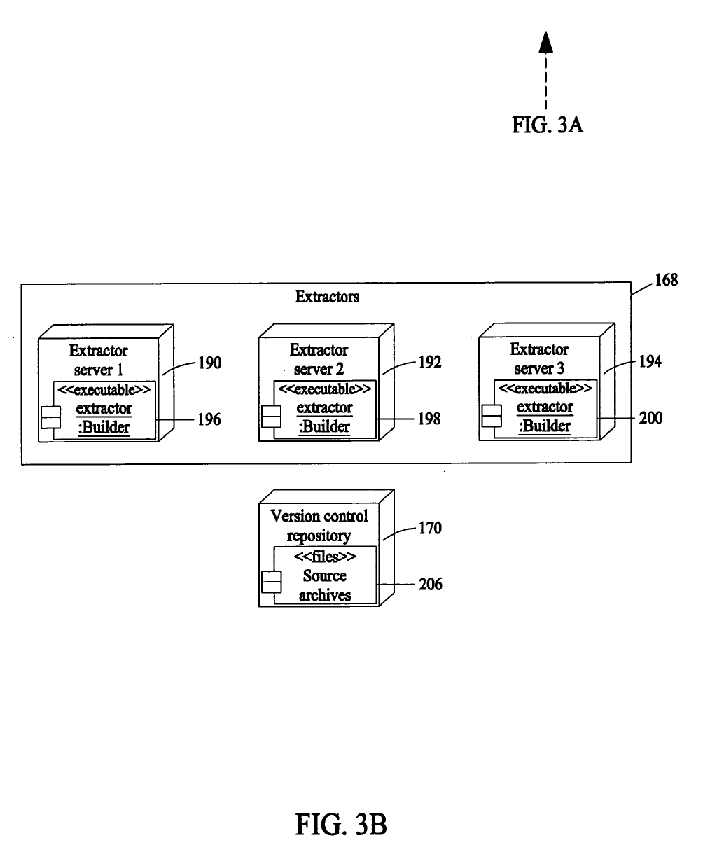

FIG. 3 is an expanded version block diagram of an example embodiment of a server farm 160 included in EBS 100 (shown in FIG. 2). Server farm 160 includes multiple servers divided into at least the following categories: a development environment 162, a staging environment 164, a production environment 166, source extractors 168, and a version control repository 170. In the example embodiment, development servers 162 include at least one of a development web server 172, and a plurality of development application servers 174. Staging servers 164 include at least one of a stage web server 178, and a plurality of stage application servers 180. Production servers 166 include at least one of a production web server 182, and a plurality of production application servers 184.

In the example embodiment, source extractors 168 include a plurality of extractor servers 190, 192, 194, which host extractors 196, 198, 200, respectively.

Development servers 162, staging servers 164, and production servers 166 host builder instances 202, 204 which perform builds and deployments. The builders connect to extractors 196, 198, 200 to retrieve source code. A connection algorithm (not shown) selects the extractor for connection based on the load level of each extractor. In the example embodiment, the extractor having the least load level is selected for connection purposes. This approach provides load balancing and fault tolerance.

Extractor servers 190, 192, 194 host builder instances 196, 198, 200, which are also referred to as extractors. These instances are configured to perform a special kind of build. More specifically, these instances extract source code from version control repository 170 and perform additional validation and reporting steps. Version control repository 170 hosts source code archives 206 which extractors 196, 198, 200 extract code from. Production web server 182 is located in a DMZ (demilitarized zone) and it is not allowed to install any extra component to this server. A builder 210 hosted by a production application server 184 deploys code to production web server 182 using scp (secured copy) method. Deployments to development web server 172 and to stage web server 178 are also performed using scp to ensure identical deployment process in all environments.

In the example embodiment, EBS 100 may be implemented generally at any operating system supporting a Java® 1.3 platform and higher.

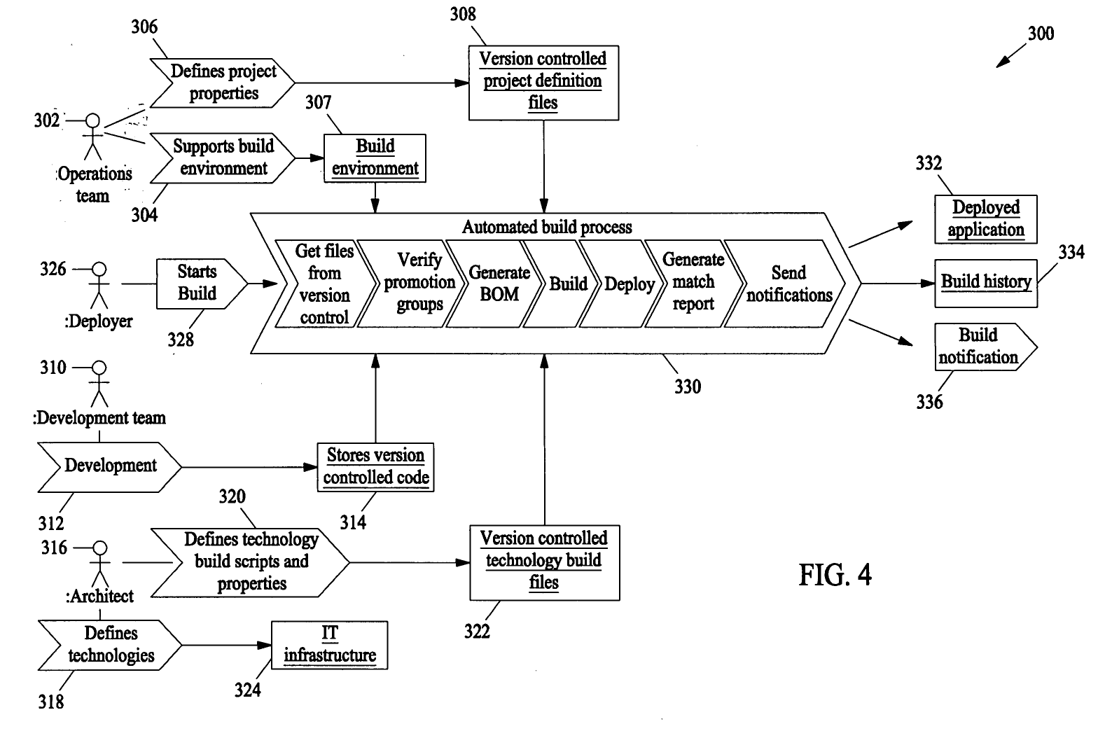

FIG. 4 is a flowchart 300 illustrating example processes utilized by EBS 100 (shown in FIG. 2) of deploying source code. The technical effect of EBS 100 is achieved when an operations team 302 supports 304 a build environment and defines 306 project build properties. A build environment 307 includes builders 202, 204 (shown in FIG. 3) and extractors 196, 198, 200 (shown in FIG. 3). Project build properties are version controlled 308.

A development team 310 develops 312 a project's product and stores 314 source code into version control repository 170 (shown in FIG. 3). In the example embodiment, compiled modules are not stored in version controlled repository 170. Moreover, in the example embodiment, SOP is not required for automated deployments, and therefore, it is not shown in FIG. 4.

An architect 316 defines 318 technologies and defines 320 technology build scripts and properties which are version controlled 322. In the example embodiment, although architectural guidelines are produced, it is not critical to communicate the architectural guidelines to development team 310 because development team 310 does not define/control deployment procedures. In the example embodiment, defining 318 technologies creates an infrastructure 324.

A deployer 326, which is either a development team 310 member (in development environment 162 (shown in FIG. 3)) or operations team 302 member (in staging environments 164 and production environments 166 (shown in FIG. 3)), starts 328 build by invoking a builder client utility. Automated build process 330 extracts source code from the version control repository, verifies promotion groups, generates bill of materials (BOM) (also referred to as a build of materials), builds compiled modules, deploys application, generates change/match report, and sends notifications to deployer 326, and mailing list defined in project properties 308. The mailing list typically includes key development team 310 members. This process results in a deployed application 332, a build history 334 such as build log files, and a build notifications 336.

In the example embodiment, architectural guidelines are incorporated into build scripts. The build process fails if the guidelines are not followed. In the example embodiment, standard operation procedures (SOP) are not used for deployments; compiled modules are not stored with source code but are built in-place; and automatic build process 330 extracts files by version label and then verifies that all files are in allowed promotion groups. File type (i.e., binary/ASCII) is defined in project definition file 308. In the example embodiment, all deployment steps are automated; and build notifications 336 contain build log files, and other attachments providing development team 310 visibility to problems should they occur.

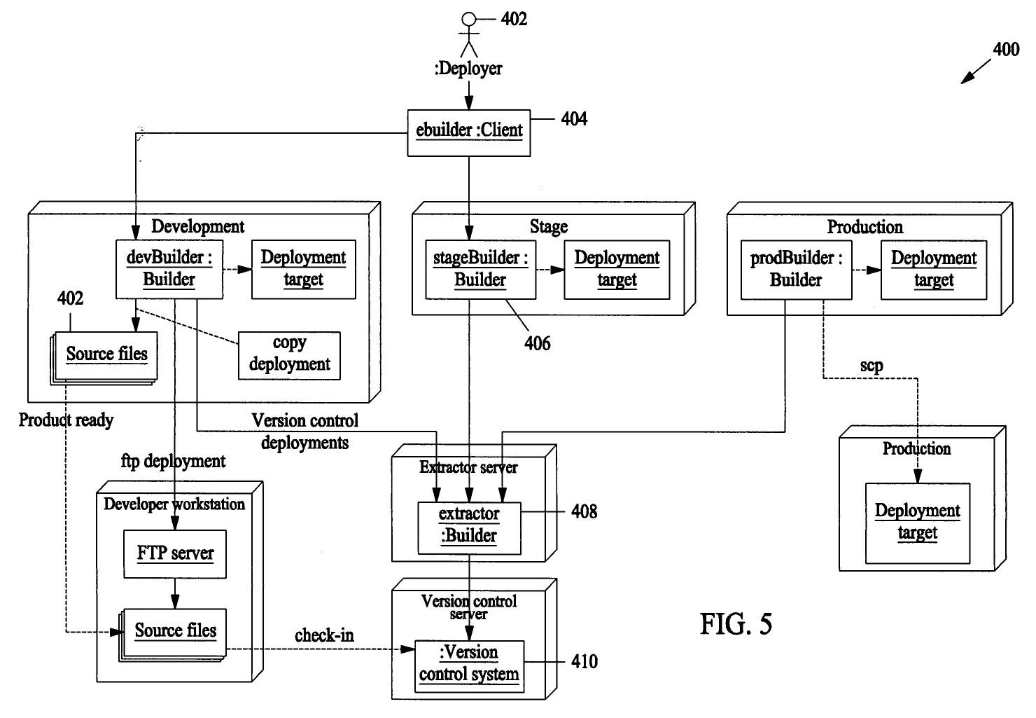

FIG. 5 is a deployment diagram 400 illustrating an example embodiment of EBS 100 (shown in FIG. 2). Deployer 402 starts a build using a client utility 404. In the example embodiment, deployer 402 provides at least one of the following parameters: (a) project name, (b) version label, and (c) additional build parameters. Client utility 404 confirms that a project name and a version label have been provided and invokes a builder 406. Builder 406 resolves an extractor 408 name using parameters communicated by deployer 402 and parameters from builder 406 configuration file. In the example embodiment, EBS 100 utilizes Java® RMI (Remote Method Invocation) over TCP/IP (Transmission Control Protocol/Internet Protocol) for network communications. Using RMI services, such as RMI over SSL (Secure Sockets Layer) and/or other security policies, allows a user to securely perform source code deployments even over public networks.

Parameters communicated by deployer 402 take precedence. Build server 406 invokes extractor 408. Build server 406 communicates parameters received from deployer 402 and parameters stored in a configuration file to extractor 408. Extractor 408 uses parameters received to resolve at least one of project and environment repository names, and version labels. Extractor 408 extracts files from a projects and environment version control repositories 410. Extractor 408 then reads project definition file extracted from projects repository and uses the information to extract project source files. Project source files are extracted based on version label provided by deployer 402. After extraction, extractor 408 asserts that revisions of files extracted are in allowed promotion groups.

Extractor 408 generates a bill of materials, which contains list of files extracted from version control repositories 410 including revision numbers and promotion group violations if any. Extractor 408 transfers extracted files and BOM (bill of materials or build of materials) to builder 406. Builder 406 resolves build properties. Builder 406 resolves build file and executes the resolved build file using resolved build properties.

In the example embodiment, Remote Method Invocation (RMI) is used for file transfer. Files are compressed before sending which allows efficient use of network bandwidth and, in concert with RMI over SSL, addresses the situation where the extractor server and the build server are in different geographic locations connected by a relatively slow public network.

In the example embodiment, builder 406 is an RMI server that performs automated builds using Ant. (Ant is a known Java based build tool that is manufactured by The Apache Software Foundation.) The build server operates as a foreground process, a background process on Unix® OS, or as a service on Windows® NT/2000/XP. (Unix is a registered trademark of American Telephone and Telegraph Company Corporation, New York, N.Y.; and Windows is a registered trademark of Microsoft Corporation, Redmond, Wash.). Builder 406 performs at least one of the following tasks: transfers files from a client to a builder, executes Ant build files, and transfers files from a builder to a client. Ant extensions, session information, an example bill of materials, and other properties relating to EBS 100 are set forth in Appendix A.

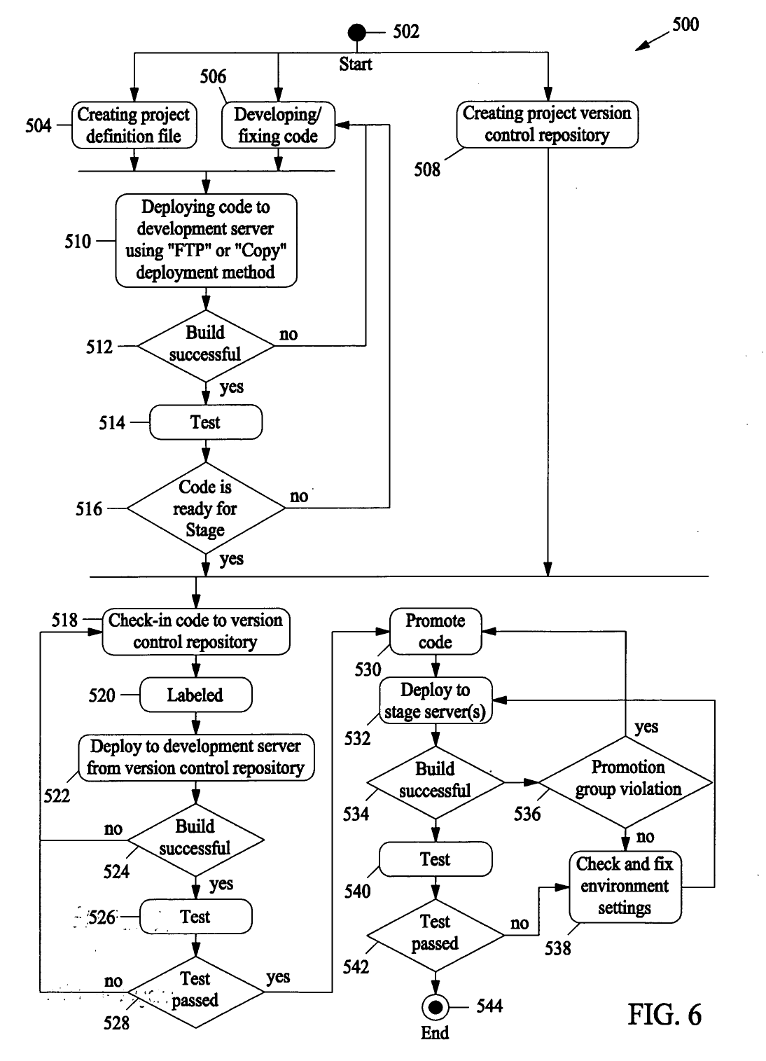

FIG. 6 is a flowchart 500 illustrating example development processes utilized by EBS 100 (shown in FIG. 2). An application (also known as a project's product) development process starts 502 with creating 504 a project definition file, developing 506 code, and creating 508 a project version control repository. Code is then deployed 510 to a development environment from a file system or a FTP server. The system then determines 512 whether the build was successful. If a build fails then the code is corrected and redeployed. Once the application is deployed successfully, the application is tested 514. After testing 514, the system determines 516 whether the code is ready for staging. Development process 506, 510, 512, 514, and 516 is repeated until the application is ready to be deployed to staging environment 164 (shown in FIG. 3).

To deploy the application to staging environment 164, the code is checked-in 518 to a version control repository and labeled 520. The application is then deployed 522 to development environment from the version control repository. The system then determines 524 whether the build was successful. A build failure means that the code was checked-in incorrectly or incompletely or improperly labeled. If a build failure occurs, steps 518 and 520 are repeated. Once the build is successful, the deployed application is tested 526. Failure to pass test 526 means that the code was checked-in incorrectly or incompletely or improperly labeled. If this occurs, steps 518-526 are repeated. Once the test is passed 528, the code is promoted 530 in the version control repository, which means it becomes eligible for deployment to staging environment 164. The application is then deployed 532 to staging environment 164.

The system then determines 534 if the build was successful. If the build fails because of a promotion group violation 536 then steps 530 and 532 are repeated. If a build failure is caused by another reason, then staging environment settings are checked 538 and corrected. Then step 532 (deploying to staging environment) is repeated. Once the application is deployed, it is tested 540. If test 540 is not passed, then steps 538 and 532 are repeated. Once test 540 is passed 542, the application is considered successfully deployed 544 to staging environment 164.

In the example embodiment, the deployment process for production environment 166 (shown in FIG. 3) is similar to the one shown herein for staging environment 164.

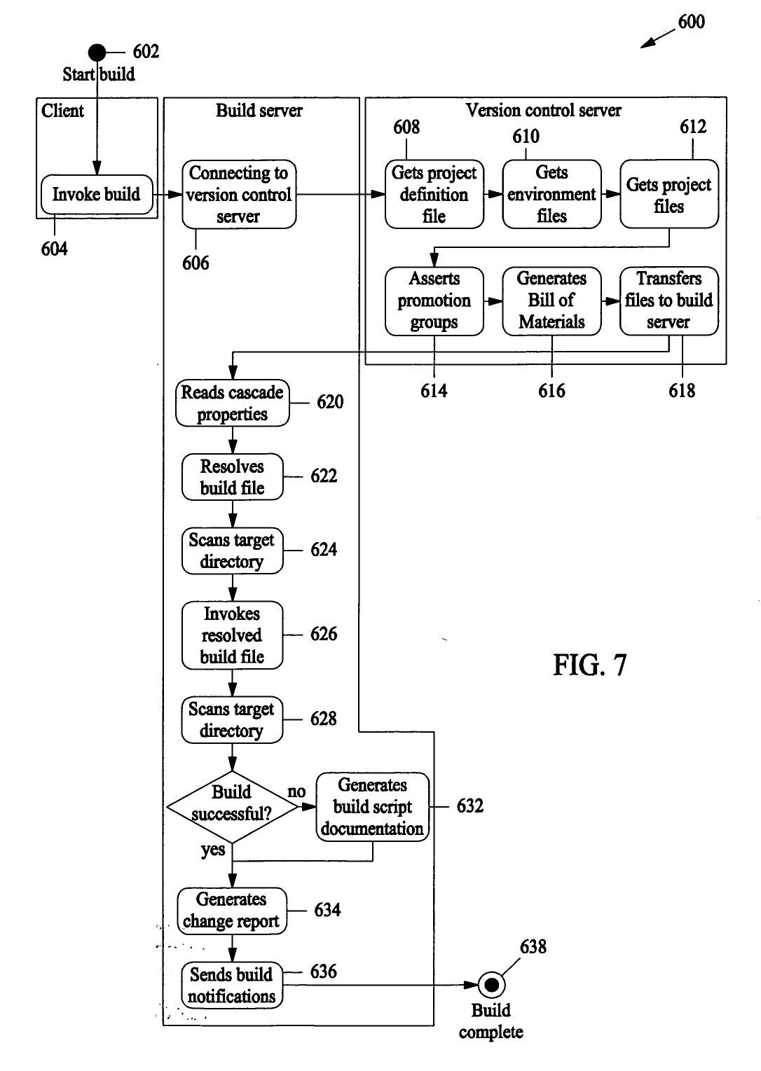

FIG. 7 is a flowchart 600 illustrating example build processes utilized by EBS 100 (shown in FIG. 2). A deployer 602 starts a build by invoking 604 a build using a client utility. Deployer 602 communicates at least one of the following parameters to the client utility: (a) project name; (b) version label; and (c) additional build parameters and properties. The client utility asserts that the project name and version label have been provided and invokes builder 406 (shown in FIG. 5) by connecting 606 to a version control server. Builder 406 resolves an extractor name using parameters passed by deployer 602 and parameters from build server configuration file. Parameters passed by deployer 602 take precedence. Builder 406 then invokes extractor 408 (shown in FIG. 5). Builder 406 passes the parameters from deployer 602 and configuration file to extractor 408.

Extractor 408 uses parameters received and parameters already stored to resolve project and environment repository names, and version labels. Extractor 408 extracts 608 the projects definition file from the version control system, then extracts 610 environment files from the version control system, then reads 612 the project definition file and extracts project files from the version control system, then asserts 614 that all files extracted are in allowed promotion groups, then generates 616 a bill of materials for the project files, and then transfers 618 extracted and generated files to the builder.

Builder 406 reads 620 cascade properties, resolves 622 build script, and scans 624 deployment directory and saves file information (i.e., name, date, size, and checksum). Builder 406 then invokes 626 resolved build script, and scans 628 deployment directory again. The system then determines 630 whether the build was successful. If the build fails, builder 406 generates 632 build script documentation to facilitate troubleshooting. Builder 406 then generates 634 a directory change report from two directory scans included in steps 624 and 628. Builder 406 sends 636 build notifications attaching build log files, bill of materials, change report, and build script documentation for failed builds. The build process is then completed 638.

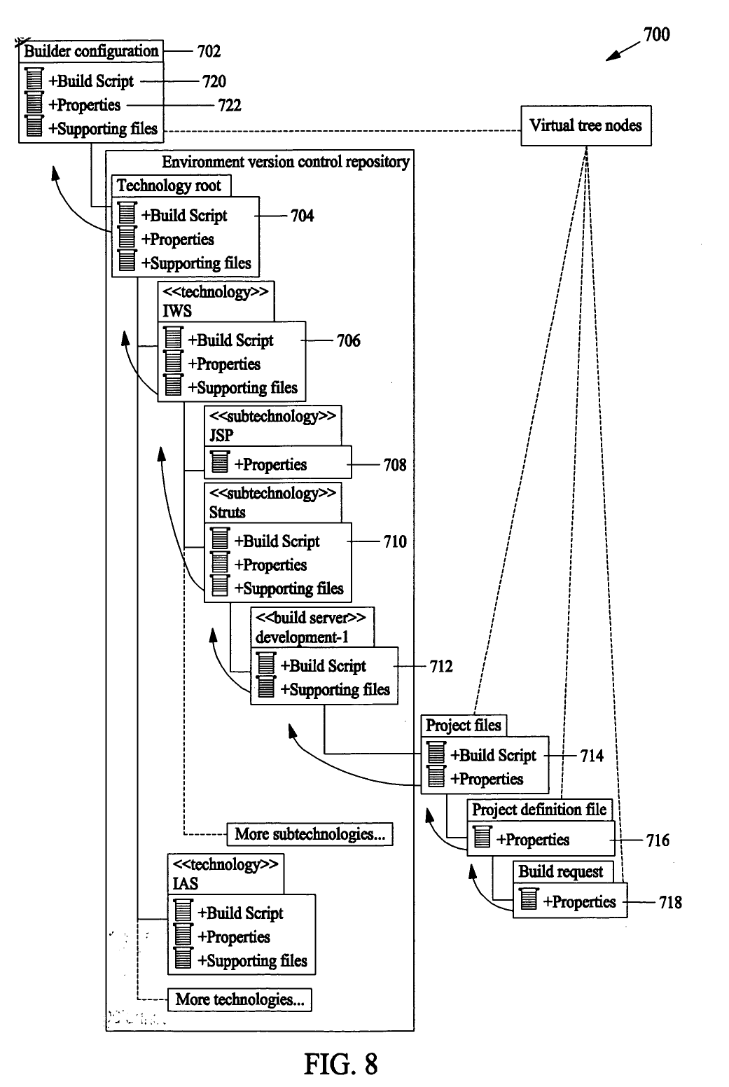

FIG. 8 is a block diagram 700 illustrating an example embodiment of a hierarchy of build sets and a property/build script resolution process for EBS 100 (shown in FIG. 2). In the example embodiment, the build process is based on a build set paradigm that includes at least one of the following build sets: a builder configuration 702, a technology root 704, a technology IWS 706, a subtechnology JSP 708, subtechnology struts 710, a build server development-1 712, projects files 714, project definition file 716, and build request 718.

Builder configuration build set 702 includes a build script 720, build properties 722, and supporting files 724. Build script 720 has a predefined name build.xml. Build properties 720 are stored in a file with a predefined name build.properties. Build script 720 name is stored in a predefined property build.file.

Build request 718 is a special case of build set, which does not contain supporting files. Project definition file 716 is a special case of build set, which contains only properties. In the example embodiment, build sets are organized in a tree. Part of the tree is stored in an environment version control repository. Builder configuration 702, project files 714, project definition file 716, and build request 718 are virtually mounted to the tree for property and build script resolution purposes.

Property and build script resolution algorithm is similar in concept to Object-Oriented programming referred to as polymorphism wherein settings on lower levels of a hierarchy override settings on higher levels. In the example embodiment, property resolution is the first step in the resolution process. Property resolution starts from reading build request properties 718, then project definition properties 711. If a property value is already set in build request properties 718 (e.g., build.file=ebuild.xml), then this property value is not changed and a setting of this property to some other value higher in hierarchy is ignored. The process repeats through build sets 714, 712, 710, 706, 704, and 702.

In the example embodiment, the resulting property set is used for build script resolution and for build script parameterization. The build script name is resolved in the following sequence: (1) if build file property is set then the value of this property is used as build script name and no further resolution is performed; (2) if project files build set 714 includes build.xml, then property build.file is set to that file's absolute path and further processing stops; and (3) step 2 is performed up to technology root 704 in the build set hierarchy until the build script is found.

The EBS therefore facilitates deployment of computer source code from a version control system to at least one of a web and application server. A technical effect of the EBS includes at least one of an automatic deployment of computer source code from a version control system to a development, a staging, and a production environment for building, compiling, packaging, and deploying files to a specific web or application server. The EBS retrieves archived source code from the version control system, performs a number of validations to determine whether the code is correct, and then deploys the code. The EBS enables a business entity to separate development and deployment processes in all environments; standardize build processes based on technology used and parameterizing these processes based on at least one of project, environment, and server; version control build files; create an isolated build environment; add pre-validation and post-validation steps to the build process; and enforce adherence with infrastructure and architectural guidelines by incorporating them into build process.

While the invention has been described in terms of various specific embodiments, those skilled in the art will recognize that the invention can be practiced with modification within the spirit and scope of the claims.

1. A method for deploying source code from a version control system to at least one of a web server and an application server using a build environment configured to be coupled to a client utility and a version control repository, said method comprising:
prompting a deployer to invoke the client utility;
extracting source code from the version control repository using the build environment;
verifying promotion groups;
building compiled modules to form an application; and
deploying the application to at least one of a web server and an application server.

2. A method in accordance with claim 1 further comprising:
generating a bill of materials for source code deployment, the bill of materials includes a list of files extracted from the version control repository including at least one of revision numbers and promotion group violations;
generating at least one of a change and match report for the source code deployment; and
sending build notifications to the deployer.

3. A method in accordance with claim 1 further comprising:
supporting the source code build environment including a plurality of builders and extractors; and
defining project build properties.

4. A method in accordance with claim 3 further comprising:
developing an application and storing source code in the version control repository by a development team; and
defining technologies and technology build scripts and properties by an architect.

5. A method in accordance with claim 1 wherein prompting a deployer to invoke a client utility further comprises:
prompting the deployer to enter into the client utility at least one of a project name, a version label, and additional build parameters; and
confirming via the client utility that at least one of a project name and a version label has been provided.

6. A method in accordance with claim 1 wherein extracting source code from the version control repository further comprises:
receiving at a builder parameters communicated by the deployer;
communicating the parameters received at the builder and parameters stored in a configuration file to an extractor; and
utilizing the extractor to extract project source files based on a version label provided by the deployer.

7. A method in accordance with claim 1 wherein building compiled modules further comprises:
transferring extracted files from an extractor to a builder;
resolving build properties and a build file; and
executing at the builder the resolved build file using resolved build properties.

8. A method in accordance with claim 1 wherein building compiled modules further comprises:
creating a project definition file;
developing source code;
creating a project version control repository; and
deploying the source code to a development environment from a file system.

9. A method in accordance with claim 8 wherein deploying the source code to a development environment further comprises:
determining whether the source code build was successful;
promoting the source code in the version control repository; and
deploying the source code from the development environment to a staging environment.

10. A method in accordance with claim 9 wherein deploying the source code from the development environment further comprises:
determining whether the source code build was successful;
promoting the source code in the version control repository; and
deploying the source code from the staging environment to a production environment.

11. A method in accordance with claim 1 further comprising connecting the client utility and the build environment via a network that includes one of a wide area network, a local area network, an intranet and the Internet.

12. A network based system for deploying source code from a version control system to at least one of a web server and an application server, said system comprising:
a version control repository,
a client utility; and
a build environment configured to be coupled to said client utility and said version control repository, said build environment comprising at least one of a development environment, a staging environment, a production environment, and a plurality of extractor servers for hosting a plurality of extractors, said build environment configured to:
extract source code from said version control repository;
verify promotion groups;
build compiled modules to form an application; and
deploy the application to at least one of a web server and an application server.

13. A system in accordance with claim 12 wherein said development environment, staging environment, and production environment host builders which perform source code builds and deployments, said builders in communication with said plurality of extractors for retrieving source code.

14. A system in accordance with claim 12 wherein said development environment comprises at least one of a development web server and a plurality of development application servers.

15. A system in accordance with claim 12 wherein said staging environment comprises at least one of a stage web server and a plurality of stage application servers.

16. A system in accordance with claim 12 wherein said production environment comprises at least one of a production web server and a plurality of production application servers.

17. A system in accordance with claim 12 wherein said build environment is further configured to:
generate a bill of materials for source code deployment, the bill of materials includes a list of files extracted from version control repositories including at least one of revision numbers and promotion group violations;
generate at least one of a change and match report for the source code deployment; and
send build notifications to a deployer.

18. A system in accordance with claim 12 wherein said build environment is further configured to define project build properties.

19. A system in accordance with claim 12 wherein said build environment is further configured to:
develop an application and store source code in said version control repository; and
define technologies and technology build scripts and properties.

20. A system in accordance with claim 12 wherein said build environment is further configured to:
prompt a deployer to enter into said client utility at least one of a project name, a version label, and additional build parameters; and
confirm that at least one of a project name and a version label has been provided.

21. A system in accordance with claim 13 wherein said build environment is further configured to:
receive at a builder parameters communicated by a deployer;
communicate the parameters received at the builder and parameters stored in a configuration file to an extractor; and
utilize the extractor to extract project source files based on a version label provided by the deployer.

22. A system in accordance with claim 13 wherein said build environment is further configured to:
transfer extracted files from an extractor to a builder;
resolve build properties and a build file; and
execute at the builder the resolved build file using resolved build properties.

23. A system in accordance with claim 13 wherein said build environment is further configured to:
create a project definition file;
develop source code;
create a project version control repository; and
deploy the source code to said development environment from a file system.

24. A system in accordance with claim 23 wherein said build environment is further configured to:
determine whether the source code build at said development environment was successful;
promote the source code in the version control repository; and
deploy the source code from said development environment to said staging environment.

25. A system in accordance with claim 24 wherein said build environment is further configured to:
determine whether the source code build at said staging environment was successful;
promote the source code in the version control repository; and
deploy the source code from said staging environment to said production environment.

26. A system in accordance with claim 12 further comprising a communication link between said build environment and said client utility, wherein said communication link includes at least one of a wide area network, a local area network, an intranet and the Internet.

27. A computer program embodied on a computer readable medium for deploying source code from a version control system to at least one of a web server and an application server, said program comprising a code segment that prompts a deployer to invoke a client utility and then:
extracts source code from the version control repository using a build environment, the build environment is configured to be coupled to the client utility and the version control repository;
verifies promotion groups;
builds compiled modules to form an application; and
deploys the application to at least one of a web server and an application server.

28. A computer program in accordance with claim 27 further comprising a code segment that:
generates a bill of materials for source code deployment, the bill of materials includes a list of files extracted from the version control repository including at least one of revision numbers and promotion group violations;
generates at least one of a change and match report for the source code deployment; and
sends build notifications to the deployer.

29. A computer program in accordance with claim 27 further comprising a code segment that:
supports the source code build environment including a plurality of builders and extractors; and
defines project build properties.

30. A computer program in accordance with claim 27 further comprising a code segment that:
develops an application and stores source code in the version control repository; and
defines technologies and technology build scripts and properties.

31. A computer program in accordance with claim 27 further comprising a code segment that:
prompts the deployer to enter into the client utility at least one of a project name, a version label, and additional build parameters; and
confirms that at least one of a project name and a version label has been provided.

32. A computer program in accordance with claim 27 further comprising a code segment that:
receives parameters communicated by the deployer;
communicates the parameters received and parameters stored in a configuration file to an extractor; and
utilizes the extractor to extract project source files based on a version label provided by the deployer.

33. A computer program in accordance with claim 27 further comprising a code segment that:
transfers extracted files from an extractor to a builder;
resolves build properties and a build file; and
executes at the builder the resolved build file using resolved build properties.

34. A computer program in accordance with claim 27 further comprising a code segment that:
creates a project definition file;
develops source code;
creates a project version control repository; and
deploys the source code to a development environment from a file system.

35. A computer program in accordance with claim 27 further comprising a code segment that:
determines whether the source code build was successful;
promotes the source code in the version control repository; and
deploys the source code from the development environment to a staging environment.

36. A computer program in accordance with claim 27 further comprising a code segment that:
determines whether the source code build was successful;
promotes the source code in the version control repository; and
deploys the source code from the staging environment to a production environment.
